(19) United States
(12) Patent Application Publication
(10) Pub. No.: US 2006/0176286 A1
(43) Pub. Date: Aug. 10, 2006

(54) Touch pad stylus with roller ball

(76) Inventors: Anthony E. Zank, (US); Paul M. Zank, (US)

Correspondence Address: SHELDON & MAK, INC, 225 SOUTH LAKE AVENUE, 9TH FLOOR, PASADENA, CA, 91101, US

(21) Appl. No.: 11/054,741

(22) Filed: Feb. 9, 2005

(51) Int. Cl. G09G 5/00

(52) U.S. Cl. 345/179

(57) ABSTRACT

A stylus useful for direct contact with an electronic touch pad has an elongate body and a dry, inkless ball disposed at the tip end of the body. The ball is attached within the elongate body, such that it is rotatable in all directions when the ball is placed in contact with an electronic touch pad.

### FIELD OF THE INVENTION

This invention relates generally to styluses and, more specifically, to styluses used with electronic touch pads.

### BACKGROUND OF THE INVENTION

Electronic touch pads have become very common as tools in banking and retail transactions. A typical electronic touch pad is adapted to receive the signature of an individual participating in such a business transaction. The touch pad in this example is connected to computer processors which can rapidly verify the authenticity of the signature.

Electronic touch pads typically require a stylus for entering information on the touch pad. Typically, such styluses are sized and dimensioned similarly to that of a common pencil or ballpoint pent.

Traditionally, such touch pad styluses have a fixed semi-pointed end which is used to impact the touch pad. However, the friction between the tip of such a prior art stylus and the touch pad makes the use of such a stylus awkward to the user. Also, the friction between such a stylus and the touch pad tends to wear out the touch pad surface.

Accordingly, there is a need for a stylus which avoids these problems with the prior art.

### SUMMARY

The invention is a stylus useful for direct contact with an electronic touch pad. The stylus comprises (a) an elongate body having a rear end and a tip end; and (b) a dry, inkless ball disposed at the tip end of the body, the ball being attached at the tip end such that the ball is rotatable in all directions when the ball is placed in contact with a touch pad. In one embodiment, the ball is made from a self-lubricating material.

### DRAWINGS

These and other features, aspects and advantages of the present invention will become better understood with reference to the following description, appended claims and accompanying drawings where:

FIG. 1 is a perspective view of a stylus having features of the invention; and

FIG. 2 is a cross-sectional side view of the stylus in FIG. 1.

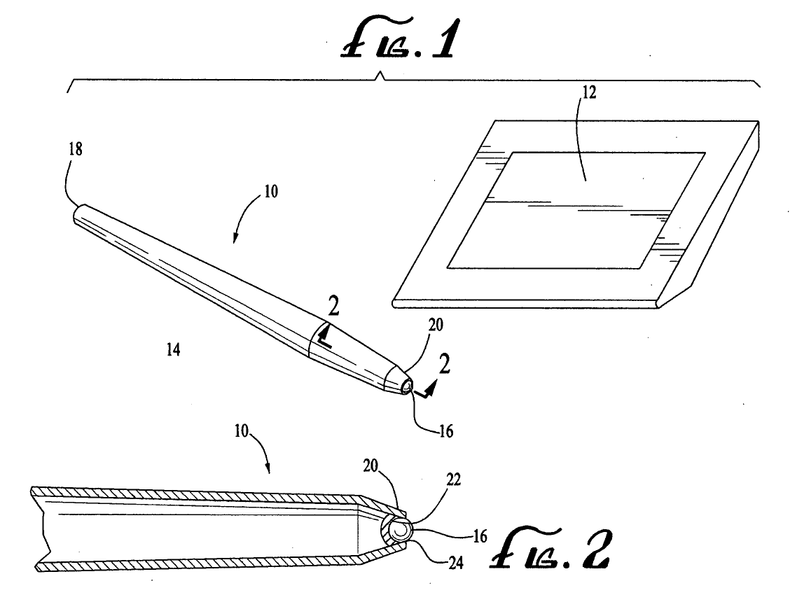

### DETAILED DESCRIPTION

The following discussion describes in detail one embodiment of the invention and several variations of-that embodiment. This discussion should not be construed, however, as limiting the invention to those particular embodiments. Practitioners skilled in the art will recognize numerous other embodiments as well.

The invention is a stylus 10 useful for directly contacting an electronic touch pad 12. The stylus 10 comprises an elongate body 14 and a dry, inkless ball 16 disposed within the body 14.

The elongate body 14 has a rear end 18 and a tip end 20. The elongate body 14 is sized and dimensioned to fit comfortably within the hand of a user. Typically, the elongate body 14 is sized and dimensioned similarly to that of an ordinary ballpoint pen.

The ball 16 is disposed at the tip end 20 of the body 14. The ball 16 is attached within the tip end 20 such that the ball 16 is rotatable in all directions when the ball 16 is placed in contact with an electronic touch pad 12. The ball 16 is retained within a ball receiving seat 22 disposed within the tip end 20. The ball 16 protrudes forwardly of the elongate body 14 through a tip apex edge opening 24.

The tip end 20, the ball receiving seat 22 and the tip apex edge opening 24 can be formed by standard techniques known to the ballpoint pen industry, such as those disclosed in U.S. Pat. No. 6,602,011, the entirety of which is incorporated herein by this reference.

The materials comprising the ball 16 and the ball receiving seat 22 are chosen so that the ball 16 rotates freely within the ball receiving seat 22 while the ball 16 is dry, e.g., so that the ball 16 generally rolls as freely as a ball within a standard ballpoint pen. In this regard, the materials comprising the ball 16 and the ball receiving seat 22 are chosen so that the coefficient of friction between the ball 16 and the ball receiving seat 22 is sufficiently small to allow the ball 16 to rotate freely within the ball receiving seat 22.

In one embodiment, the ball 16 is made from a self-lubricating material, that is a material known in the art to have natural lubricity. In a typical embodiment, the ball 16 is made from a self-lubricating plastic material. Such a self-lubricating plastic material is one which is substantially comprised of acetyl resin. Such acetyl resins are sold under the Delrin® trademark by RM Plastics, Inc. of Lake of the Ozarks, Mo.

In embodiments wherein the ball 16 is made from a resin or similar material, additional lubricity can be imparted to the ball 16 by mixing the resin with materials of greater natural lubricity, such as with Teflon® fibers sold by E.I. Dupont De Nemours and Company of Wilmington, Del.

The invention is also the combination of the stylus described above and an electronic touch pad.

Having thus described the invention, it should be apparent that numerous structural modifications and adaptations may be resorted to without departing from the scope and fair meaning of the instant invention as set forth hereinabove and as described hereinbelow by the claims.

What is claimed is:

1. A stylus useful for direct contact with an electronic touch pad, the stylus comprising:
(a) an elongate body having a rear end and a tip end; and
(b) a dry, inkless ball disposed at the tip end of the body, the ball being attached at the tip end such that the ball is rotatable in all directions when the ball is placed in contact with a touch pad.

2. The stylus of claim 1 wherein the ball is made from a self-lubricating material.

3. The stylus of claim 1 wherein the ball is made from a self-lubricating plastic material.

4. The stylus of claim 1 wherein the ball is made from acetyl resin.

5. A stylus and electronic touch pad combination comprising:
(a) the stylus of claim 1; and
(b) an electronic touch pad.

6. The stylus of claim 5 wherein the ball is made from a self-lubricating material.

7. The stylus of claim 5 wherein the ball is made from a self-lubricating plastic material.

8. The stylus of claim 5 wherein the ball is made from acetyl resin.
